(19) United States
(12) Patent Application Publication
(10) Pub. No.: US 2007/0187973 A1
(43) Pub. Date: Aug. 16, 2007

(54) Bump pattern rear facing seat footrest

(75) Inventor: Steven W. Houston, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/353,444

(22) Filed: Feb. 14, 2006

(51) Int. Cl. B60N 3/06

(52) U.S. Cl. 296/75

(57) ABSTRACT

A utility vehicle comprising a front end, a rear end opposite the front end, a polymeric footrest, and a plurality of polymeric traction promoting features. The footrest is mounted at the rear end and extends from the rear end of the vehicle. The traction promoting features are integral with the footrest and protrude from an upper surface of the footrest.

### FIELD

The present teachings relate to a method and apparatus for a utility vehicle.

### BACKGROUND

The statements in this section merely provide background information related to the present disclosure and may not constitute prior art.

Utility vehicles can comprise a rear seat assembly for passengers, which can face the rear of the vehicle. The rear seat assembly can include a footrest extending from the rear end of the vehicle. While current rear seat footrests are suitable for their intended uses, they are subject to improvement.

### SUMMARY

The present teachings provide for a utility vehicle comprising a front end, a rear end opposite the front end, a polymeric footrest, and a plurality of polymeric traction promoting features. The footrest is mounted at the rear end and extends from the rear end of the vehicle. The traction promoting features are integral with the footrest and protrude from an upper surface of the footrest.

The present teachings also provide for a footrest for a utility vehicle comprising a polymeric body having an upper surface and a lower surface opposite the upper surface; a plurality of polymeric traction promoting features integral with the footrest and protruding from the upper surface; and a longitudinal axis extending through each one of the plurality of traction promoting features. The traction promoting features are orientated such that their respective longitudinal axes are one of perpendicular and parallel to each other.

The present teachings further provide for a footrest for a utility vehicle comprising a body having an upper surface and a lower surface opposite the upper surface. A plurality of traction promoting features protrude from the upper surface. The traction promoting features each comprise a first side surface, a second side surface parallel to the first side surface, and a longitudinal axis extending between the first and the second side surfaces and parallel to the first and the second side surfaces. A plurality of rows of the traction promoting surfaces extend across the upper surface. A plurality of columns of the traction promoting surfaces extend across the upper surface. The longitudinal axes are one of parallel and perpendicular to each other.

Further areas of applicability will become apparent from the description provided herein. It should be understood that the description and specific examples are intended for purposes of illustration only and are not intended to limit the scope of the present disclosure.

### DRAWINGS

The skilled artisan will understand that the drawings described herein are for illustration purposes only and are not intended to limit the scope of the present teachings in any way.

FIG. 1 is a perspective view of a utility vehicle according to the various embodiments;

FIG. 2 is plan view of a portion of an undersurface of the utility vehicle of FIG. 1;

FIG. 3 is an exploded perspective view of a footrest and rear door assembly of the utility vehicle of FIG. 1;

FIG. 4 is a close-up perspective view of a plurality of friction promoting surfaces provided on the footrest of FIG. 3;

FIG. 5 is a perspective view of one of the friction promoting surfaces of FIG. 4;

FIG. 6A is a perspective view of the footrest and rear door assembly of the utility vehicle of FIG. 1, a door of the door assembly illustrated in a closed position;

FIG. 6B is a perspective view of the footrest and rear door assembly of the utility vehicle of FIG. 1, the door of the rear door assembly illustrated in an open position;

FIG. 7 is an exploded perspective view of the footrest and rear door assembly of the utility vehicle of FIG. 1;

FIG. 8A is a cross-sectional view of FIG. 6A illustrating the cooperation between a first hinge of the rear door and a first hinge receptacle, the rear door at a closed position;

FIG. 8B is a cross-sectional view of FIG. 6B illustrating the cooperation between the first hinge of the rear door and the first hinge receptacle, the rear door at an open position;

FIG. 9 is a cross-sectional view of the first hinge of FIG. 8A removed from the first hinge receptacle;

FIG. 10 is a perspective view of a seatback assembly of the utility vehicle of FIG. 1;

FIG. 11 is a top view of a seatback cushion of the seatback assembly of FIG. 10;

FIG. 12 is a rear view of the seatback cushion of FIG. 11; and

FIG. 13 is a cross-sectional view taken along line 13-13 of FIG. 12.

### DETAILED DESCRIPTION

The following description is merely exemplary in nature and is in no way intended to limit the present disclosure, application, or uses. Throughout this specification, like reference numerals are used to refer to like elements.

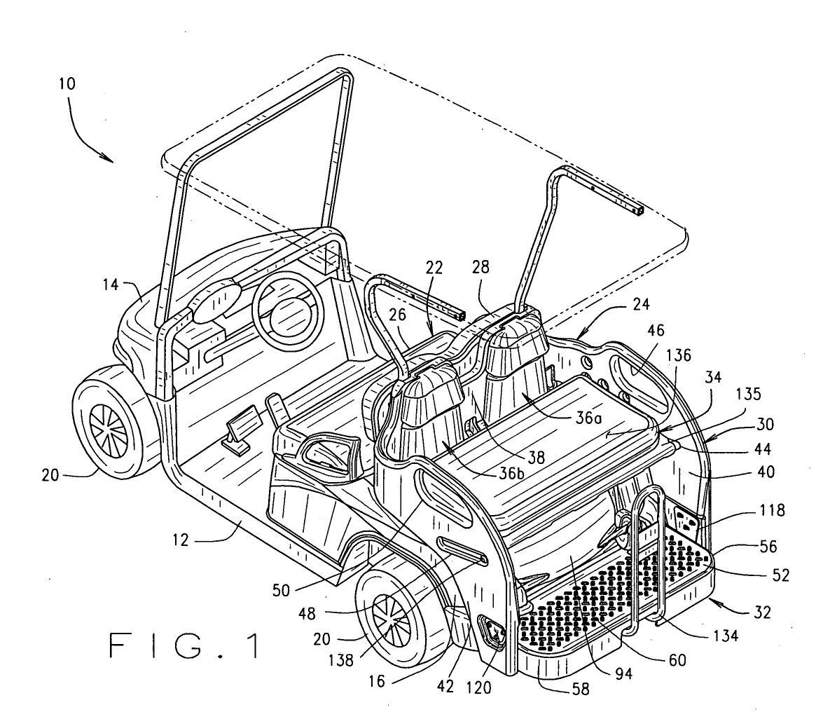

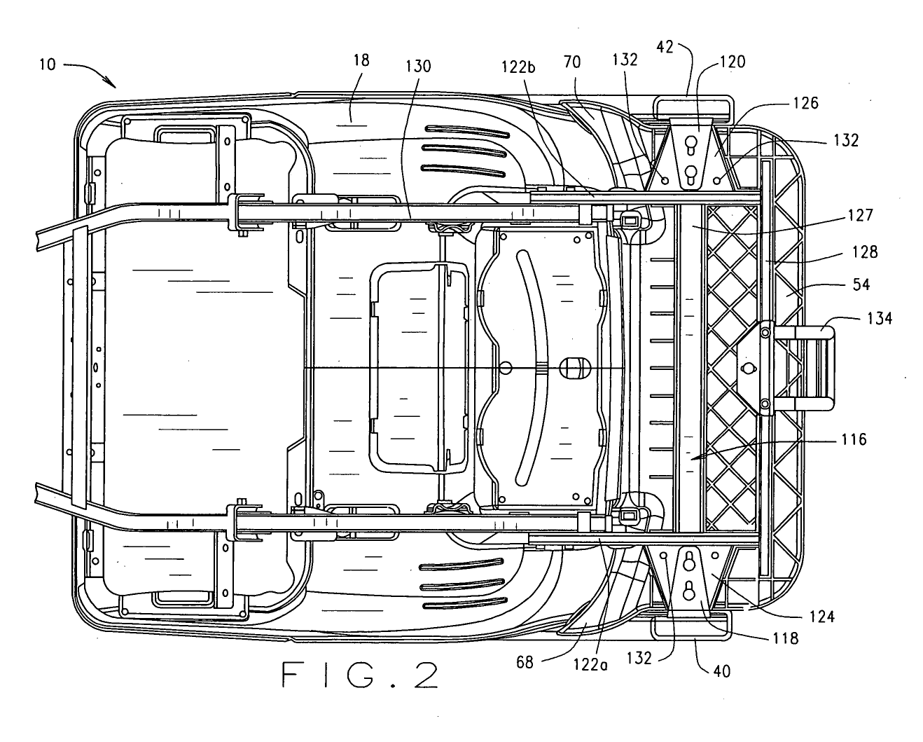

A utility vehicle in accordance with the present teachings is illustrated in FIG. 1 at reference numeral 10. The utility vehicle 10 can comprise a main body 12 having a front end 14, a rear end 16, and an undersurface 18 (a portion of which is illustrated in FIG. 2). The main body 12 can be supported by a plurality of wheels 20.

A front seat assembly 22 can face the front end 14 of the main body 12. A rear seat assembly 24 can face the rear end 16. The front seat assembly 22 can comprise a front main seat 26 and a front seatback 28. The front seatback 28 can be mounted to the rear seat assembly 24. The front seat assembly 22 can be used by the operator of the utility vehicle. The rear seat assembly 24 can comprise a rear seat frame 30, a footrest 32, a main rear seat 34, and at least one rear seatback assembly 36a/36b.

The seat frame 30 can be a generally “U”-shaped frame that can extend from the front seat assembly 22 to the rear end 16 of the vehicle 10. The seat frame 30 can comprise a base portion 38, a first side wall 40, and a second side wall 42. The first side wall 40 can include a first slot 44 and a first handle 46. The second side wall 42 can include a second slot 48 and a second handle 50. The seat frame 30 can be made from a variety of materials known in the art, such as from a suitable polymer material.

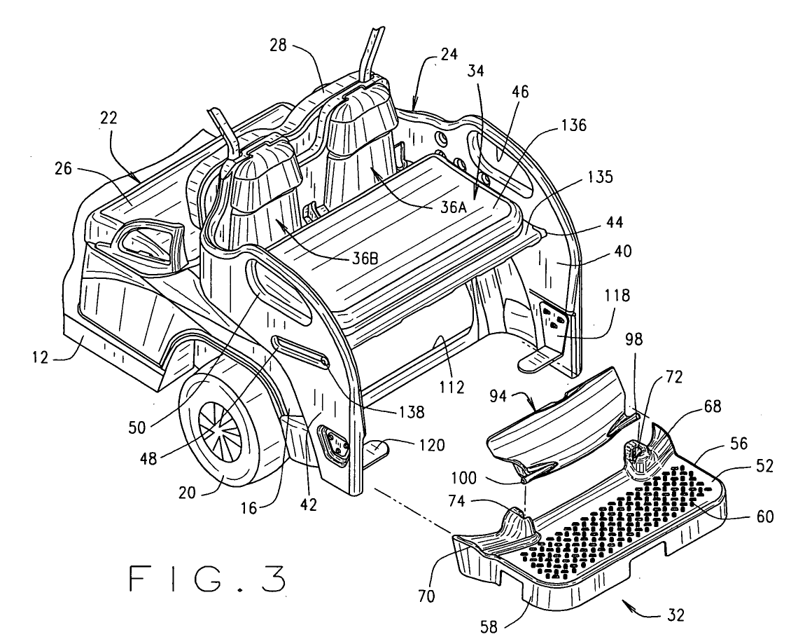

With continued reference to FIGS. 1 and 2 and additional reference to FIGS. 3-7, the footrest 32 can generally include an upper surface 52, a lower surface 54 (FIG. 2) opposite the upper surface 52, a first side surface 56, and a second side surface 58. The footrest can be comprised of any suitable polymeric material, such as polypropylene.

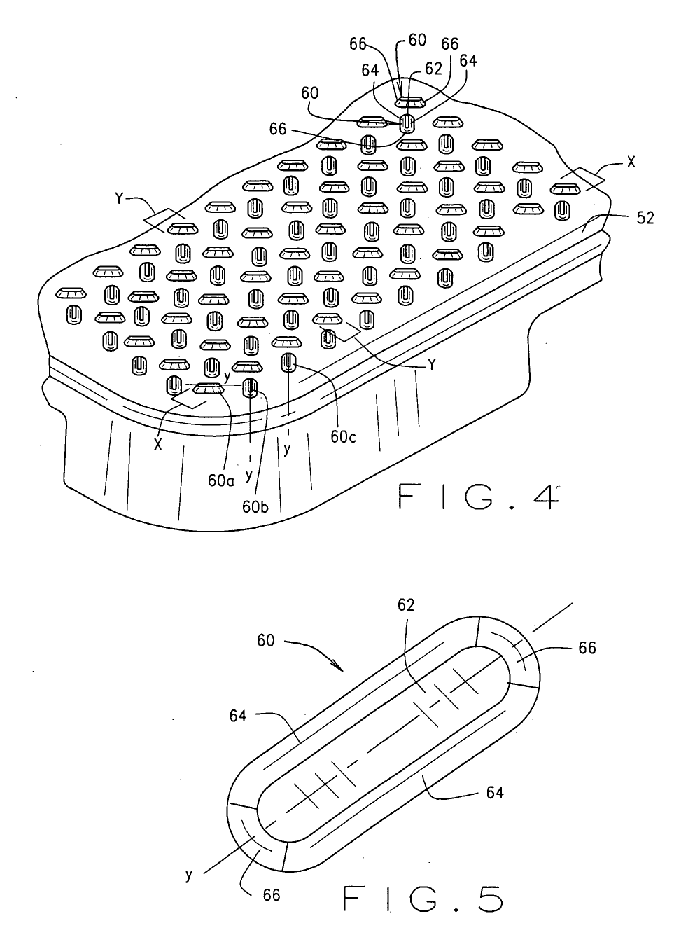

The upper surface 52 can be integral with or directly transition to the first and second side surfaces 56 and 58. For example, there can be no side wall around the periphery of the upper surface 52, thereby allowing water, dirt, and other materials to easily drain or be removed from the upper surface 52. The upper surface 52 can comprise a plurality of traction promoting surfaces, which can take the form of raised surfaces or bumps 60. As illustrated in FIGS. 4 and 5, the bumps 60 can be at least substantially the same and can each comprise a top surface 62, parallel side surfaces 64, and end surfaces 66 that can extend between the parallel side surfaces 64. The side surfaces 64 can be longer than the end surfaces 66 to provide the bumps 60 with a generally rectangular shape. The bumps 60 can comprise a longitudinal axis y extending parallel to the side surfaces 64 and perpendicular to the end surfaces 66.

The bumps 60 can generally be arranged in a series of rows X and columns Y. Bumps 60 in neighboring rows X or columns Y can be orientated ninety degrees relative to each other such that the longitudinal axes y of the neighboring bumps 60 can be perpendicular to each other. For example, bump 60a is orientated such that its longitudinal axis y is perpendicular to the longitudinal axis y of bump 60b in the neighboring row X or column Y. Neighboring bumps 60 in the same row X or column Y can be orientated so that their respective longitudinal axes y are parallel. For example, bump 60b is orientated such that its longitudinal axis y is parallel to the longitudinal axis y of the bump 60c in the same row X. The shape and orientation of the bumps 60 can provide a slip resistant surface and can allow water to drain off of the upper surface 52 between the bumps 60. The bumps 60 can be formed on the footrest 32 using a variety of different techniques. For example, the bumps 60 can be molded or stamped within the footrest 32.

With reference to FIGS. 3, 6, and 7, the footrest 32 can also comprise a first trim portion 68 and a second trim portion 70. The first and second trim portions 68 and 70 can be generally curved to approximate the contours of the rear end 16 of the utility vehicle 10.

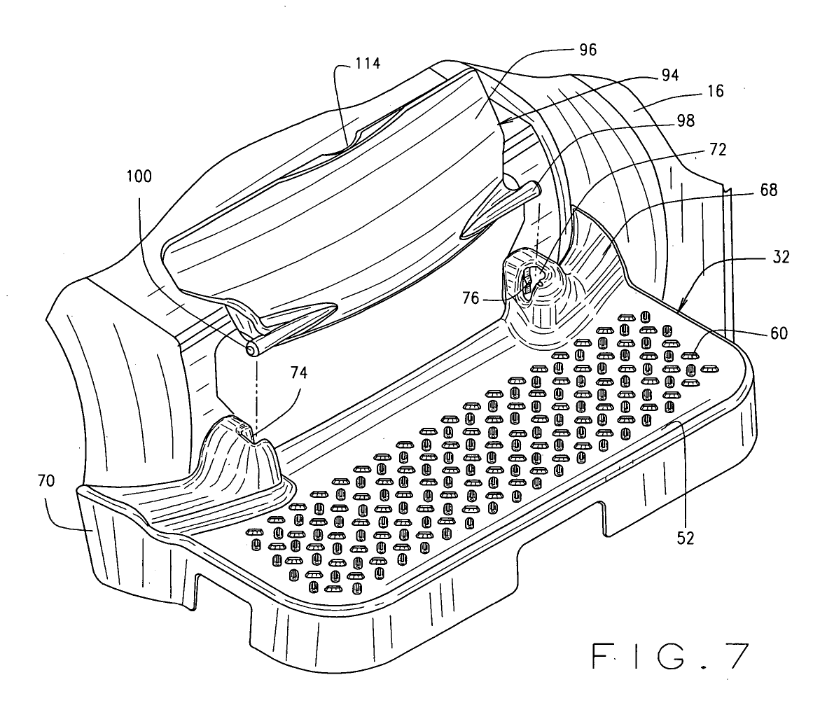

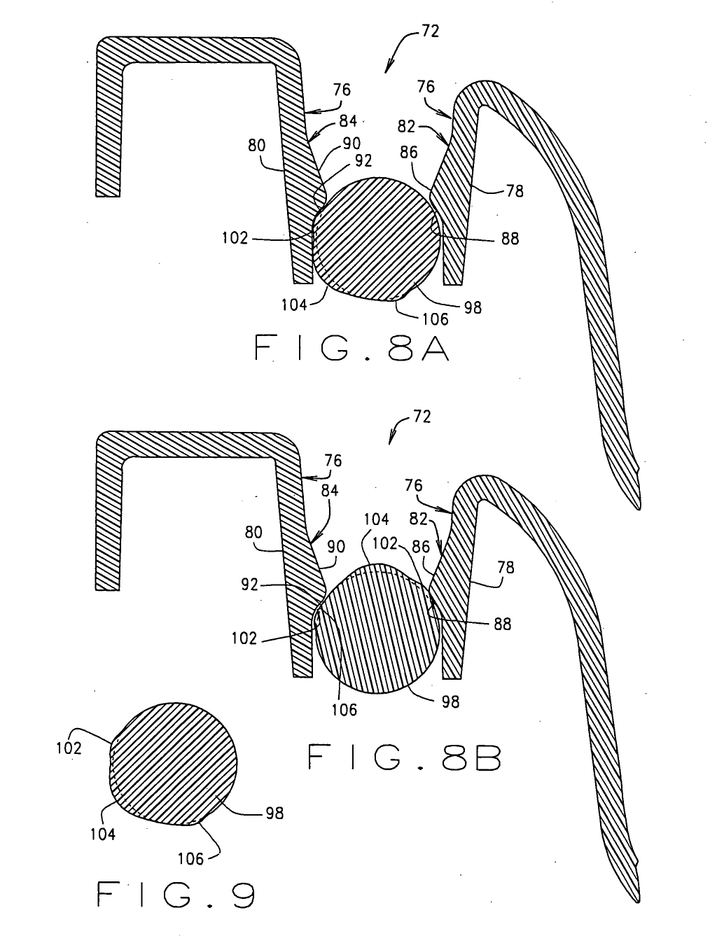

With reference to FIGS. 3 and 6-8, the footrest 32 can further comprise a first hinge receptacle 72 and a second hinge receptacle 74. The first and second hinge receptacles 72 and 74 can be positioned generally opposite each other. The first hinge receptacle 72 can comprise a first locking mechanism 76 (FIGS. 7 and 8). The second hinge receptacle 74 can also comprise a locking mechanism (not shown), which can be generally the same as the first locking mechanism 76. Because the first locking mechanism 76 can be generally the same as the second locking mechanism, the description provided herein of the first locking mechanism 76 can also generally apply to the second locking mechanism.

With particular reference to FIG. 8, the first locking mechanism 76 can comprise a first flange 78 and a second flange 80. The first flange 78 can comprise a first locking detail 82, and the second flange 80 can comprise a second locking detail 84. The first and second locking details 82 and 84 can protrude from the first and second flanges 78 and 80, respectively, inward toward the first hinge receptacle 72. The first locking detail 82 can include an upper surface 86 and a lower surface 88. The second locking detail 84 can include an upper surface 90 and a lower surface 92.

With continued reference to FIGS. 1, 3, and 6-9, the first and second hinge receptacles 74 and 76 can rotationally receive portions of a door 94. The door 94 can comprise a main panel 96, a first hinge post 98, and a second hinge post 100. The door 94 can be made of any suitable material. For example, the door 94 can be made of a suitable polymer material. Each of the first hinge post 98 and the second hinge post 100 can extend from opposite sides of the main panel 96. The first hinge post 98 can be at least generally similar to the second hinge post 100. Therefore, the description of the first hinge post 98 below can equally apply to the second hinge post 100. With reference to FIGS. 8 and 9, the first hinge post 98 has a generally cylindrical cross-section. However, the first hinge post 98 can include a first cam surface 102, a second cam surface 104, and a third cam surface 106. The first, second, and third cam surfaces 102, 104 and 106 can protrude from the first hinge post 98.

The first and second hinge posts 98 and 100 can be rotationally mounted within the first and second hinge receptacles 72 and 74, respectively. The first hinge post 98 can be mounted between the first flange 78 and the second flange 80. The hinge post 98 can be mounted such that it is seated below the lower surface 88 of the first locking detail 82 and the lower surface 92 of the second locking detail 84. Therefore, the first and second locking details 82 and 84 can retain the first hinge post 98 within the first hinge receptacle 72. The second hinge post 100 can be retained within the second hinge receptacle 74 in a similar manner. Therefore, the description of the cooperation between the first hinge post 98 and the first hinge receptacle 72 is sufficient to describe the cooperation between the second hinge post 100 and the second hinge receptacle 74.

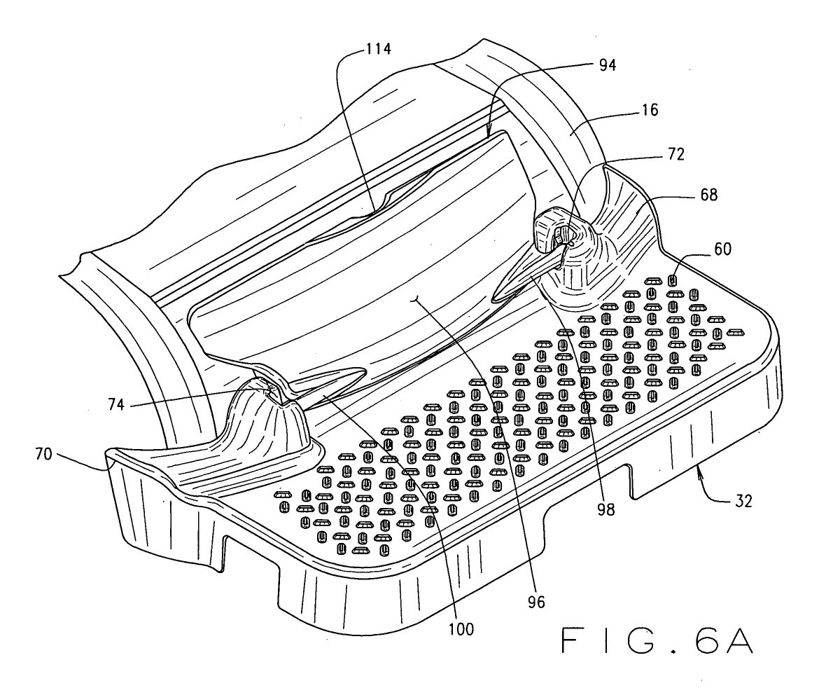

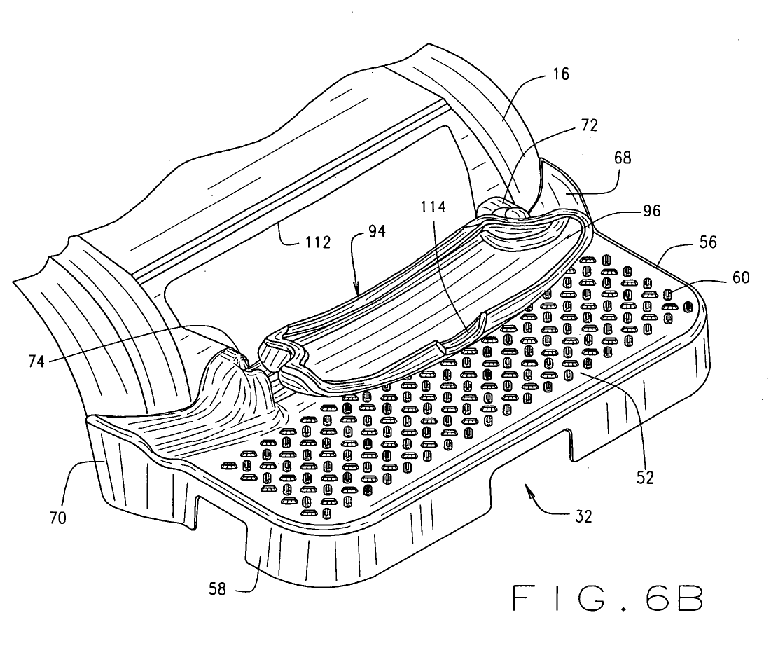

With reference to FIGS. 6 and 8, the door 94 can be moved between a closed position (FIGS. 6A and 8A) and an open position (FIGS. 6B and 8B) in which the door 94 can be positioned parallel with the footrest 32. In the open position the door 94 can permit access to an opening 112 at the rear end 16 of the utility vehicle 10. In the closed position the door 94 can cover the opening 112 and restrict access to the opening 112. As illustrated in FIG. 8A, the door 94 can be retained in the closed position through interaction between the lower surface 92 of the second locking detail 84 and the first cam surface 102, as well as interaction between the second cam surface 104 and the second flange 80.

To move the door 94 to the open position (FIG. 8B), the door 94 can be rotated (clockwise in FIG. 8B) such that the first and second cam surfaces 102 and 104 can pass across and beyond the second locking detail 84. The door 94 can be opened until the first cam surface 102 contacts the first locking detail 82 and the third cam surface 106 contacts the lower surface 92 of the second locking detail 84. Thus, the first and second locking details 82 and 84 can act as stops to prevent the door 94 from being over-rotated when opened. To move the door 94 from the open position (FIG. 8B) to the closed position (FIG. 8A), rotational force sufficient to permit passage of the second cam surface 104 past the second locking detail 84 is applied and the door is returned to the position of FIGS. 6A and 8A.

To facilitate movement of the door 94 between the open and closed positions, the door 94 can further comprise a handle 114. As illustrated in FIGS. 6 and 7, the handle 114 can comprise a recess in a top portion of the door 94. The handle 114 can also comprise any other suitable device that can facilitate the opening and closing of the door 94.

With renewed reference to FIGS. 1-3, the footrest 32 can be mounted at the rear end 16 of the vehicle 10 between the first side wall 40 and the second side wall 42 of the rear seat frame 30. The footrest 32 can be mounted into position using a main bracket 116 (FIG. 2), a first side bracket 118, and a second side bracket 120. The main bracket 116 can comprise weldment members 122a and 122b, a first weld stud 124, a second weld stud 126, a first crossbeam support member 127, and a second crossbeam support member 128. The weldment members 122a and 122b can be generally parallel to each other. The weldment members 122 can each include through holes (not shown) that can accept a suitable fastening device to mount the main bracket 116 to a vehicle frame 130 at the undersurface 18 of the vehicle 10. The first weld stud 124 can extend from the weldment member 122a and the second weld stud 126 can extend from the weldment member 122b. The weldstuds 124 and 126 can each include one or more apertures 132 that can be configured to receive studs (not shown) that can be formed on the lower surface 92 of the footrest 32. The first and second crossbeam support members 127 and 128 can extend between each of the weldment members 122a and 122b. The second crossbeam support member 128 can include through holes at approximately a center portion of said support member.

The main bracket 116 can be mounted to the undersurface 18 of the utility vehicle 10 using a suitable fastening device to couple the weldment members 122a and 122b to the vehicle frame 130. The footrest 32 can be secured to the main bracket 116 by inserting studs, such as molded studs, which can extend from the lower surface 54 of the footrest 32, within the apertures 132 of the first and second weld studs 124 and 126. The studs can be secured within the apertures 132 using a suitable fastening device or method, such as flanged nylon lock nuts.

The footrest 32 can be further supported by the first and second side brackets 118 and 120. The first side bracket 118 can have a first portion that mounts to the first side wall 40 using a suitable fastener and a second portion that mounts to the first weld stud 124 to secure the main bracket 116 to the seat frame 30. The second side bracket 120 can also have a first portion that that mounts to the second side wall 42 using a suitable fastener and a second portion that mounts to the second weld stud 126 to further secure the main bracket 116 to the seat frame 30. The footrest 32 can be mounted at an angle such that a portion of the footrest 32 closest to the rear end 16 of the vehicle 10 can be higher, or further from a ground surface that the vehicle 10 is placed upon, than a portion of the footrest 32 furthest from the rear end 16 of the vehicle. Mounting the footrest 32 at an angle can facilitate drainage of water off of the upper surface 52 of the footrest 32.

As illustrated in FIGS. 1-2, a support device, such as a grab handle 134, can be mounted to the second crossbeam support member 128 of the main bracket 116. The grab handle 134 can be mounted to the second crossbeam support member 128 using any suitable fastening device or method. The grab handle 134 can be used for support by a passenger sitting on the rear seat assembly 24.

With reference to FIGS. 1 and 3, the main seat 34 can extend between the first side wall 40 and the second side wall 42. The main seat 34 can comprise a seat base 135 and a cushion 136 mounted to the seat base 135. A first seat flange (not shown) and a second seat flange 138 can extend from opposite sides of the seat base 135. The first seat flange can engage the first slot 44 of the first side wall 40 and the second seat flange 138 can engage the second slot 48 of the second side wall 42 to mount the main seat 34 in the seat frame 30. The main seat 34 can be rotationally mounted to permit the cushion 136 to be rotated approximately 180° to convert the main seat 34 into a cargo deck.

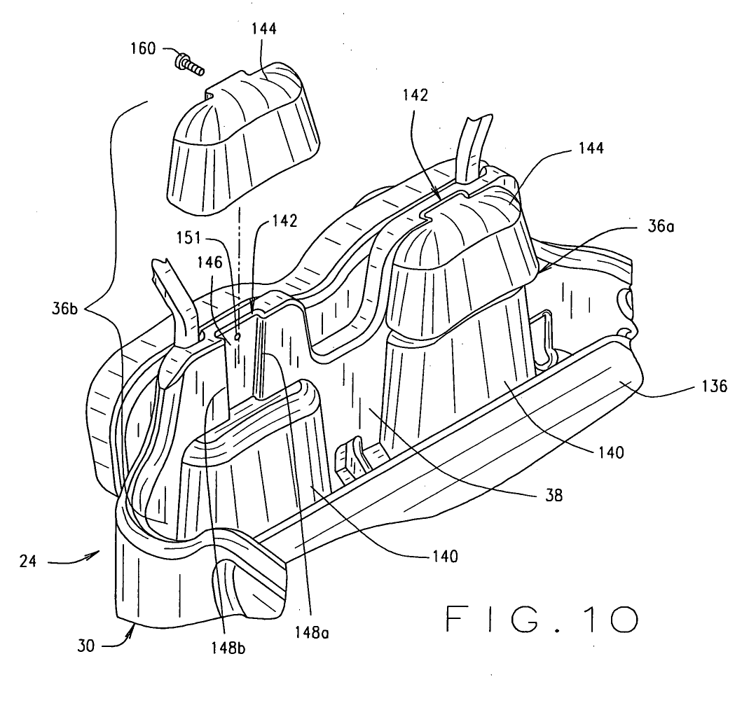

With reference to FIG. 10, a first seatback assembly 36a and a second seatback assembly 36b are illustrated, although the vehicle can include less than or more than two seatback assemblies 36. As illustrated, each seatback assembly 36a and 36b can be generally similar. Therefore, the like features of the two seatback assemblies 36a and 36b are referred to in the Figures using like reference numbers. The description of the seatback assemblies 36a and 36b herein does not distinguish between the different assemblies 36a and 36b because they can be substantially the same.

The seatback assembly 36 can be located at the base portion 38 of the seat frame 30. The seatback assembly 36 can include a seatback base 140, a seat cushion receptacle 142, and a seatback cushion 144. The seatback base 140 can protrude from the base portion 38 of the seat frame 30 and can be formed or molded with the base portion 38. The base portion 38 can be made of the same material as the seat frame 30 or a different material. By way of non-limiting example, the base portion 38 can be made of a suitable polymeric material.

The seat cushion receptacle 142 can be provided in the base portion 38 above the seatback base 140. The receptacle 142 can include a recess 146 within the base portion 38 and a pair of flanges 148a and 148b that extend from the recess. The receptacle 142 can be tapered such that the distance between the flanges 148a and 148b can decrease in the direction of the seatback base 140.

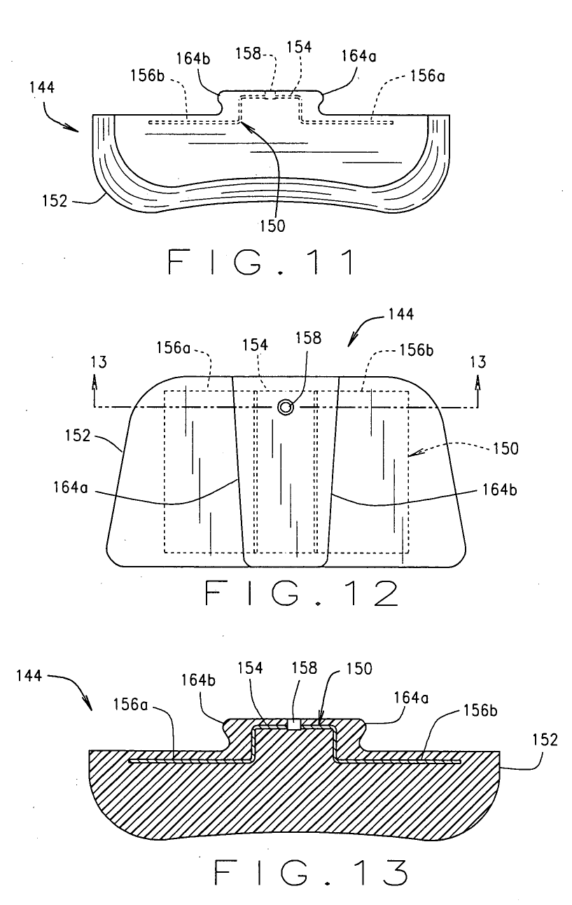

As illustrated in FIGS. 11-13, the seatback cushion 144 can include a frame 150 and a cover 152. The frame 150 can comprise a center portion 154 between a first periphery portion 156a and a second periphery portion 156b. The center portion 154 can be offset from the first and second periphery portions 156a and 156b. The center portion can include a nut 158 that can be operable to receive a suitable fastening device, such as a bolt 160. The frame 150 can be made of any suitable material, such as low carbon steel.

The seatback cushion 144 can further comprise a pair of flanges 164a and 164b that can protrude from the cover 152. The flanges 164a and 164b can be tapered to correspond to the tapered flanges 148 of the seat cushion receptacle 142. The center portion 154 of the frame 150 can be between the flanges 164.

The cover 152 can be formed over the frame 150 to trap the frame 150 within the cover 152. By way of non-limiting example, the frame 150 can be placed in a mold suitable to form the cushion 144. A suitable material, such as self-skinning polyurethane foam, can be injected into the mold to form the cover 152. Because the frame 150 is also in the mold, the frame 150 will be trapped inside of the cover 152.

As illustrated in FIG. 10, the cushion 144 can be secured to the seat frame 30 by sliding the flanges 164 of the cushion 144 into cooperation with the flanges 148 of the seat cushion receptacle 142. To secure the cushion 144 in the receptacle, 142 the fastener 160 can be inserted through an aperture 151 of the recess 146 and into cooperation with the nut 158 of the frame 150. The nut 158 and the aperture 151 can be positioned such that they are not in complete alignment until the cushion is compressed further into the receptacle 142. Thus, when the fastener 160 is threaded through the aperture 151 and into cooperation with the nut 158, the cushion 144 is secured in a compressed state, which can improve the fit between the cushion 144 and the receptacle 142.

To remove the cushion 144 from cooperation with the receptacle 142, the fastener can be removed from cooperation with the nut 158 and the cushion 144 can be lifted out of engagement with the receptacle 142. The cushion 144 can be inserted and removed from cooperation with the receptacle 142 as desired depending on the application. For example, the cushion 144 can be removed if the seat assembly 24 is being used to haul cargo to protect the seat cushion 144 from being damaged. On the other hand, the cushion 144 can be attached to the receptacle 142 when the rear seat assembly 24 is being used for passengers to provide them with a comfortable surface on which to rest their back.

As set forth above, the front seatback 28 can be directly mounted to the rear seat frame 30. Therefore, there is no need for a gap between the front seatback 28 and the rear seat frame 30 to accommodate an independent support for the front seatback 28. The elimination of such a gap allows the rear seat assembly 24 to be moved closer to the front end 14 of the vehicle 10, thereby permitting the size of the rear seat assembly 24 to be increased.

The description herein is merely exemplary in nature and, thus, variations that do not depart from the gist of that which is described are intended to be within the scope of the disclosure. Such variations are not to be regarded as a departure from the spirit and scope of the disclosure.

What is claimed is:

1. A utility vehicle comprising:
a front end;
a rear end opposite said front end;
a polymeric footrest mounted at said rear end and extending from said rear end of said vehicle; and
a plurality of polymeric traction promoting features integral with said footrest and protruding from an upper surface of said footrest.

2. The utility vehicle of claim 1, wherein said traction promoting features comprise a plurality of bumps each having:
a first side surface;
a second side surface that is parallel to said first side surface;
a first end surface between said first and said second side surfaces;
a second end surface between said first and said second side surfaces that is opposite said first end surface; and
a longitudinal axis extending parallel to said first and said second side surfaces and through said first and said second end surfaces.

3. The utility vehicle of claim 2, wherein said traction promoting features are arranged in a plurality of rows and columns.

4. The utility vehicle of claim 3, wherein said traction promoting features in neighboring said rows and neighboring said columns are orientated such that their respective said longitudinal axes are perpendicular.

5. The utility vehicle of claim 3, wherein said traction promoting features in common said rows and common said columns are orientated such that their respective said longitudinal axes are parallel.

6. The utility vehicle of claim 1, wherein said footrest is mounted to said vehicle at an angle such that said footrest is not parallel to an undersurface of said vehicle.

7. The footrest of claim 1, wherein said polymeric material comprises polypropylene.

8. A footrest for a utility vehicle comprising:
a polymeric body having an upper surface and a lower surface opposite said upper surface;
a plurality of polymeric traction promoting features integral with said footrest and protruding from said upper surface; and
a longitudinal axis extending through each one of said plurality of traction promoting features;
wherein said traction promoting features are orientated such that their respective longitudinal axes are one of perpendicular and parallel to each other.

9. The footrest of claim 8, wherein said traction promoting surfaces each comprise a plurality of bumps having:
a first side surface;
a second side surface that is parallel to said first side surface;
a first end surface between said first and said second side surfaces; and
a second end surface between said first and said second side surfaces that is opposite said first end surface;
wherein said longitudinal axis extends parallel to said first and said second side surfaces.

10. The footrest of claim 8, wherein said traction promoting surfaces are arranged in a plurality of rows and columns.

11. The footrest of claim 8, wherein said polymeric material comprises polypropylene.

12. The footrest of claim 10, wherein said longitudinal axes of said traction promoting surfaces of adjacent said rows and adjacent said columns are perpendicular.

13. The footrest of claim 10, wherein said longitudinal axes of said traction promoting surfaces of common said rows and common said columns are parallel.

14. A footrest for a utility vehicle comprising:
a body having an upper surface and a lower surface opposite said upper surface;
a plurality of traction promoting features protruding from said upper surface, said traction promoting features each comprising:
a first side surface;
a second side surface parallel to said first side surface;
a longitudinal axis extending between said first and said second side surfaces and parallel to said first and said second side surfaces;
a plurality of rows of said traction promoting surfaces extending across said upper surface;
a plurality of columns of said traction promoting surfaces extending across said upper surface;
wherein said longitudinal axes are one of parallel and perpendicular to each other.

15. The footrest of claim 14, wherein said footrest and said traction promoting surfaces comprise a polymeric material.

16. The footrest of claim 15, wherein said polymeric material comprises polypropylene.

17. The footrest of claim 14, wherein said longitudinal axes of said traction promoting surfaces of adjacent said rows and adjacent said columns are perpendicular.

18. The footrest of claim 14, wherein said longitudinal axes of said traction promoting surfaces of common said rows and common said columns are parallel.
